(19) United States
(12) Patent Application Publication
(10) Pub. No.: US 2003/0215024 A1
(43) Pub. Date: Nov. 20, 2003

(54) Modulation apparatus, modulation method, modulated wave receiving apparatus, and modulation system

(75) Inventor: Yutaka Miyahara, Kawagoe-shi (JP)

Correspondence Address: ARMSTRONG,WESTERMAN & HATTORI, LLP, 1725 K STREET, NW, SUITE 1000, WASHINGTON, DC, 20006, US

(73) Assignee: PIONEER CORPORATION, Tokyo (JP)

(21) Appl. No.: 10/436,198

(22) Filed: May 13, 2003

(30) Foreign Application Priority Data
May 17, 2002 (JP) 2002-142964

(51) Int. Cl. H04L 27/04; H04L 27/12

(52) U.S. Cl. 375/295

(57) ABSTRACT

Receiving levels of electric waves in a peripheral area are detected by an FM level detector 11 in an FM modulator 2. A reference frequency band in which the receiving level in which the receiving level is lowest in a plurality of reference frequency bands among a plurality of frequency bands stored in a memory 13 is selected. Date is modulated by a modulator 12 in the selected reference frequency band, and frequency band information for the reference frequency band to which a frequency of the data was modulated is superimposed on the modulated data and then the modulated data the frequency band information superimposed thereon is transmitted in the form of a digital signal. The transmitted frequency band information is received by an FM multiplex decoder in a head unit 3. An FM tuner 26 is controlled based on the frequency band information received by a system controller, and the data is fetched by attenuating signals other than those in the reference frequency band to which a frequency of the data was modulated.

### BACKGROUND OF THE INVENTION

1. Field of the Invention

The present invention relates to a modulation apparatus and a method for modulating data to those in a prespecified frequency band, a modulated wave receiving apparatus for receiving the modulated data, and to a modulation system equipped with the modulation apparatus or the modulated wave receiving apparatus.

2. Description of Related Art

In the conventional technology, there has been known the configuration in which a modulation apparatus is used for transmitting and receiving data. This modulation apparatus modulates and transmits, for instance, received music data to those in an ultrahigh frequency band in the range from 30 to 300 MHz. The modulation apparatus based on the conventional technology as described above has a memory, a frequency converter, an input configurator, a conversion controller, and a transmitter.

The memory stores therein a plurality frequency bands for data conversion. The frequency converter can fetch data and converts the fetched data to those in a prespecified reference frequency band. The input configurator has, for instance, a plurality of operation buttons. When a user selected any of the operation buttons, the input configurator selects and enables one of the reference frequency bands according to the user's choice. The conversion controller controls the frequency converter, and makes the data modulated in the frequency converter based on the reference frequency band selected in the input configurator. The transmitter has an antenna for transmission. The transmitter transmits the data modulated to those in the specified reference frequency band with the frequency controller via the transmission antenna.

The data transmitted from this converter is received, for instance, by an FM broadcast signal receiving apparatus. The data received by this FM broadcast signal receiving apparatus is sent to a data reproducing apparatus and reproduced therein. With the configuration as described above, for instance, when a drive for reading music data recorded in a CD-DA (Compact Disk-Digital Audio) is connected to the modulation apparatus, it is not necessary to connect the drive to the data reproducing apparatus via an electric cable. Further the music data stored in the modulation apparatus with the drive connected thereto can be reproduced with a data reproducing apparatus provided at a remote site, which improves the convenience.

The reference frequency band for modulating data is decided by determining the situation of electric waves in the area where the user uses the modulation apparatus. Namely the user recognizes the state of a frequency of the information provided through FM broadcasting or TV broadcasting in the area where the user uses the modulation apparatus. Then the user selects a reference frequency band not affected by the frequency of the provided information, and operates a corresponding operation button in the input configurator to enable the reference frequency band. Because of the configuration described above, for instance, if the modulation apparatus is to be used in other area, it is necessary to again recognize the situation of the electric wave in the area for enabling another reference frequency band in which the data to be modulated is hardly affected.

### SUMMARY OF THE INVENTION

The present invention was made in the light of the circumstances as described above, and it is a main object of the present invention to provide a modulation apparatus and a method for automatically modulating data to those in a better frequency band, a modulated wave receiving apparatus for automatically fetching the automatically modulated data, and a modulation system for automatically fetching the automatically modulated data.

The modulation apparatus according to the present invention comprises a data fetching section for fetching data; a level detector for receiving electric waves in a peripheral area and detecting the receiving levels (amplitude of receiving waves); a frequency configurator for identifying and selecting, based on the level of the received wave detected by this level detector, a frequency band in which the receiving level is low as a reference frequency band; and a frequency modulator for modulating the data fetched with the data fetching section to those in the reference frequency band set by the frequency configurator.

In this invention, the frequency configurator identifies and selects, based on the levels of the received waves in the peripheral area detected by the level detector, a frequency band in which the receiving level is low, as the reference frequency band, and then the frequency modulator modulates the data fetched by the data fetching section in this reference frequency band. With the configuration, modulation of data can automatically be carried out in a frequency band not affected by electric waves in the peripheral area, which results in improvement of the convenience.

The modulation apparatus according to the present invention comprises a storage for storing therein a plurality of frequency bands corresponding to a plurality of different frequency bands as the reference frequency bands, and the frequency configurator preferably compares receiving levels (amplitudes) of electric waves detected by the level detector in the reference frequency bands stored in the storage to each other, and selects a frequency band in which the receiving level is lowest as the reference frequency band.

In the present invention, the frequency configurator compares receiving levels detected by the level detector in the reference frequency bands stored in the storage to each other, and selects a frequency band in which the receiving level is lowest as the reference frequency band. Because of this feature, automatic modulation of data is performed in a frequency area not easily affected by electric waves in the peripheral area with the simple configuration.

In the modulation apparatus according to the present invention, the frequency configurator preferably compares level (s) of received waves detected by the level detector to a reference value previously set, recognized the frequency bands in which the receiving levels of electric waves are lower than the reference value, and sets at least one of the recognized frequency bands as the reference frequency band.

In this invention, the frequency configurator compares levels of waves received by the level detector to a reference value previously set, and when any frequency bands in which receiving levels of electric waves are not more than the reference value are detected, at least one of the frequency bands is set as the reference frequency band. Because of this feature, a frequency band not easily affected by electric waves in the peripheral area can easily be identified with the simple configuration, so that data modulation can easily and automatically be carried out.

The modulation apparatus according to the present invention preferably comprises a transmitter for transmitting modulated data and frequency band information concerning the reference frequency band to which the data has been modulated.

In this invention, the transmitter transmits the modulated data and frequency band information concerning the reference frequency band to which the data has been modulated. Because of this feature, a frequency band to which data is modulated can be recognized even for data automatically modulated data, and the modulated data can automatically be received.

The modulation apparatus according to the present invention preferably superimposes the frequency band information in the form of digital signals on the modulated data for transmission.

In this invention, the frequency band information is superimposed in digital signals on the modulated data and transmitted. Because of this feature, the frequency band information is transmitted simultaneously together with the data, so that the efficiency in transmitting and receiving modulated data is substantially improved.

A modulation method according to the present invention is one in which a frequency of fetched data is modulated to a prespecified frequency data by a computing section, and this method is characterized in that electric waves in a peripheral area are received to detect levels of the received waves, a frequency band in which the levels of the received waves are low is recognized and the frequency band is set as a reference frequency band, and a frequency of fetched data is converted to that in this reference frequency band set as described above.

Because of this feature, the same effects as those provided by the modulation apparatus according to the present invention described above are provided.

In the modulation method according to the present invention, the configuration of the modulation apparatus according to the present invention described above can be employed, and the same effects as those provided by the modulation apparatus are provided.

The modulated wave receiving apparatus according to the present invention comprises an information fetching section for fetching the frequency band information concerning a reference frequency band for the data modulated by the modulation apparatus according to the present invention described above, and a data receiver for receiving the modulated data by attenuating signals for frequency band information other than those in the reference frequency band fetched by this information fetching section.

In this invention, data can automatically be modulated by the modulation apparatus according to the present invention in a frequency band not affected by electric waves in a peripheral area, and further the frequency information concerning a reference frequency band for the data modulated by the modulation apparatus according to the present invention is fetched by the information fetching section, and then data is fetched by the data receiver by attenuating signals for frequency band information other than those in the fetched reference frequency band.

Because of the feature described above, even the data automatically modulated in a frequency band not affected by electric waves in the peripheral area can be fetched in response to the frequency band of the data, so that automatically modulated dada can easily be fetched.

The modulated wave receiving apparatus preferably comprises a storage for storing therein a plurality of different frequency bands as reference frequency bands, and the frequency configurator compares levels of waves detected by the level detector to those in each of the reference frequency bands stored in the storage, and sets the frequency band in which the detected level is lowest as a reference frequency band.

In the present invention, frequency information concerning a reference frequency band of data modulated by the modulation apparatus according to claim 2 enabling automatic modulation of data in a frequency band not easily affected by electric waves in the peripheral area with the simple configuration is fetched by the information fetching section, and of the reference frequency bands stored in the storage of the modulation apparatus, a reference frequency band corresponding to the fetched frequency information is recognized by the data receiver, and the modulated data is fetched by attenuating signals in frequency bands other than the reference frequency band. Because of this feature, even the data automatically modulated in a frequency band not affected by electric waves in the peripheral area can be fetched in response to the frequency band of the data, and thus automatically modulated data can easily be fetched with the simple configuration.

The modulation system according to the present invention comprises the modulation apparatus according to the present invention described above and the modulated wave receiving apparatus according to the present invention also described above.

The present invention comprises the modulation apparatus according to any of claims 1 to 5 capable of automatically modulating data in a frequency band in which data modulation is not affected by electric waves in the peripheral area, and the modulated waves receiving apparatus capable of easily fetching, in response to a frequency band of data automatically modulated, the automatically modulated data. With this operation, data can easily be transmitted and received without being affected by electric waves in the peripheral area, which improves the convenience.

The modulation system according to the present invention can comprise a reproducing apparatus for reproducing data fetched by the data receiver in the modulated wave receiving apparatus according to the present invention described above.

In the present invention, there is provided a reproducing apparatus for reproducing data fetched by the data receiver in the modulated wave receiving apparatus in the modulation system described above. Because of this feature, the present invention is especially advantageous for the configuration in which data is transmitted and received for reproduction thereof, and the transmitted and received data is reproduced as it is without being affected by electric waves in the peripheral area, which improves the convenience.

### BRIEF DESCRIPTION OF THE DRAWINGS

FIG. 1 is a block diagram showing general configuration of the modulation system according to a first embodiment of the present invention;

FIG. 2 is a flow chart showing operations of the modulation according to the first embodiment of the present invention; and

FIG. 3 is a flow chart showing operations of a modulation system according to a second embodiment of the present invention.

### DETAILED DESCRIPTION OF PREFERRED EMBODIMENT(S)

Embodiments of the present invention are described below with reference to the present invention.

[First Embodiment]

(Configuration of the Modulation System)

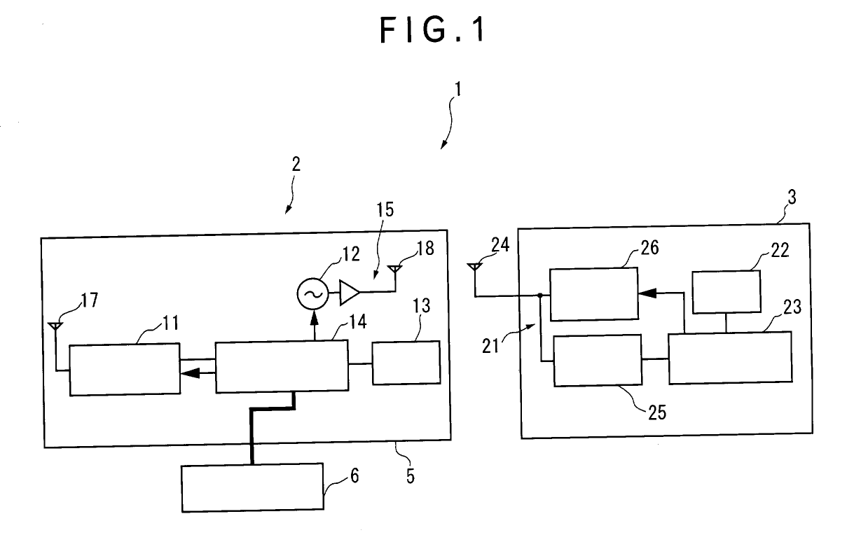

FIG. 1 is a block diagram showing general configuration of a modulation system according to a first embodiment of the present invention. In FIG. 1, the reference numeral 1 indicates a modulation system, and this modulation system 1 comprises an FM modulator 2 as a modulation apparatus, a head unit 3 as a modulated wave receiving apparatus, and a reproducing apparatus now shown in the figure. The modulation system 1 is a system in which data such as music data fetched with the FM modulator 2 is modulated so that the data is not affected by electric waves in the peripheral area, the modulated data is transmitted from the FM modulator 2 and received by the head unit 3, and is reproduced by the reproducing apparatus.

The FM modulator 2 comprises a modulation apparatus 5, a controller 6 as an input device, and a power source section now shown in the figure. The modulation apparatus 5 comprises an FM level detector 11 as a level detector, a modulator 12 as a frequency modulator, a memory 13 as a storage, a frequency controller 14 as a frequency configurator, and a transmitter 15.

The FM level detector 11 has a receiving antenna 17. The FM level detector 11 receives electric waves in an area in which the modulation system 1 is used with the receiving antenna 17 to determine the situation of received electric waves. Namely the FM level detector 11 receives with the receiving antenna 17 electric waves such as high frequency waves for information provided through, for instance, FM broadcasting or TV broadcasting in the area where the modulation system is used, and detects levels of the received electric waves. Data concerning the receiving levels is sent to the frequency controller 14.

Connected to the modulator 12 is, for instance, a data reader now shown. This modulator 12 can fetch data read with the data reader. Then the modulator 12 modulates a frequency of the fetched data to that in a prespecified frequency band. Various modulation methods such as level modulation or frequency modulation may be used for modulating the frequency.

As the data reader, a drive or a connector capable of reading data such as music data recorded in a recording medium such as a CD-DA (Compact Disk-Digital Audio), a CD-ROM (Compact Disk-Read Only Memory), a DVD-ROM (Digital Versatile Disc-Read Only Memory), or a magnetic card may be used. It is to be noted that the present invention is not limited to this configuration.

A RAM (Random Access Memory) or a ROM (Read Only Memory) may be used as the memory 13. Information for a plurality of, for instance, n frequency bands is stored in this memory 13. This frequency band information comprises a plurality of, for instance, n pieces of ID information each having the respective identity such as “Freq. n (n: natural number)” and a plurality of, n pieces of reference frequency bands related to the ID information respectively in a form of a pair. Namely, the memory 13 has a table structure in which ID information and respective reference frequency bands are stored as frequency band information in the form of a pair respectively.

Also a preset threshold value Th is stored in the memory 13. This threshold value Th is a criterion for determination of receiving levels of electric waves and is used for comparison to the receiving levels of electric waves detected by the FM level detector 11. Namely the threshold value Th is a reference value, and when receiving levels of electric waves are over this reference value, the information may not be received by the head unit smoothly.

The frequency controller 14 is connected to the FM level detector 11. The frequency controller 14 fetches data for the receiving level detected by the FM level detector 11. Also the memory 13 is connected to the frequency controller 14. The frequency controller 14 compares receiving levels of electric waves in the peripheral area fetched from the FM level detector 11 to the frequency band information stored in the memory 13. Further the frequency controller 14 selects information for a frequency band hardly affected at the receiving level of electric waves in the peripheral area, namely a frequency in which the receiving level of the electric waves in the peripheral area is lowest from the frequency band information stored in the memory.

The frequency controller 14 controls the modulator 12 to provide controls for modulating a frequency of data to that in a reference frequency band corresponding to the selected frequency band information. When providing controls for modulation with the modulator 12, the frequency controller 14 provides controls for superimposing the ID information for frequency band information on the data to be modulated, for instance, in the form of digital signals.

Further the frequency controller 14 compares the threshold value Th stored in the memory 13 to receiving levels of electric waves detected by the level detector 11, and determines whether the receiving levels of the electric waves are over the threshold value Th or not. When the frequency controller 14 determines that the receiving levels of the electric waves are over the threshold value Th, the modulator 12 executes the processing for changing the reference frequency band for modulation of the data.

The transmitter 15 has an antenna 18 for transmission. This transmitter 15 transmits data modulated by the modulator 12 with ID information for frequency band information superimposed thereon.

The controller 6 is connected to the frequency controller 14 in the modulation apparatus 5. The controller 6 has a plurality of operating switches used by a user, for instance, to input data. The controller 6 makes the FM modulator 2 execute various types of operations when the operating switches are operated to input data.

A power source not shown supplies power to each component, for instance, when a power switch (not shown) of the controller 6 is turned ON, to run the entire FM modulator 2. This power source has, for instance, a power cord to supply power from a commercial AD power source, or has a connector, to which a cell or a battery is connected, to receive power from the cell or the battery.

On the other hand, the hear unit 3 fetches information transmitted from the FM modulator 2. This head unit 3 comprises a receiver 21, a terminal memory 22 as a terminal storage, a system controller 23, and a terminal power source not shown. Further the receiver 21 comprises a receiving antenna 24, an FM multiplex decoder 25 as an information fetching section, and an FM tuner 26 as a data receiver.

The FM multiplex decoder 25 in the receiver 21 fetches ID information for frequency band information described in the information received via the receiving antenna 24. The multiplex decoder 25 outputs ID information for the fetched frequency band information to the system controller 23.

The FM tuner 26 of the receiver 21 has a filter now shown to attenuate signals other than those in a prespecified frequency band. This FM tuner 26 passes the information received via the receiving antenna 24 through a filter, and fetches the data modulated by the modulation apparatus 2. Then the FM tuner 26 outputs the fetched data to a reproducing apparatus.

Such a device as a RAM or a ROM is used for the terminal memory 22 like for the memory 13 of the FM modulator 2. This terminal memory 22 has the frequency band information stored therein like that stored in the memory 13.

The system controller 23 is connected to the FM multiplex decoder 25, FM tuner 26, and to the terminal memory 22 respectively. The system controller 23 identifies the ID information for the frequency band information fetched in the FM multiplex decoder 25 and verifies the information to the frequency band information stored in the terminal memory 22. With this verification, the system controller 23 identifies the frequency band information having the same ID information as that stored in the terminal memory 22, and also identifies the reference frequency band related to the ID information of this frequency band information as the reference frequency band to which the frequency of the data was modulated by the FM modulator 2. Then the system controller 23 controls the FM tuner 26 to make it process and fetch the information received via the filter in the identified reference frequency band.

The terminal power source supplies power to each component to run the entire head unit 3, like the power source for the FM modulator 2, when a power switch not shown is turned ON.

The reproducing apparatus has a sound-generating section not shown such as a speaker to reproduce, for instance, music data. Then the reproducing apparatus fetches the data fetched by the FM tuner 26 in the head unit 3 and outputs the data as sounds with the sound-generating section to reproduce the data.

(Operations of the Modulation System)

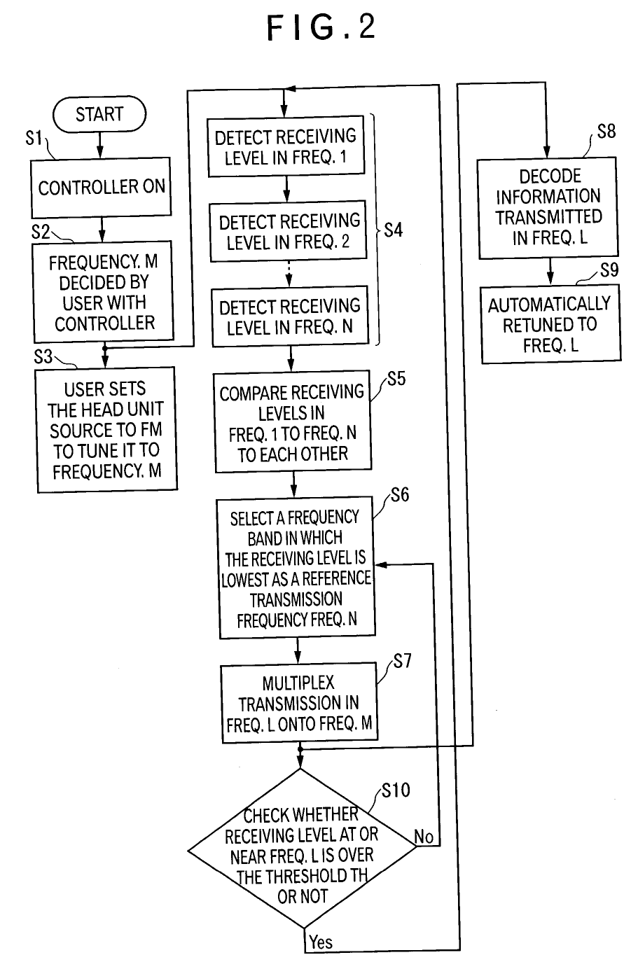

Operations of the modulation system according to the first embodiment are described below with reference to the related drawings. FIG. 2 is a flow chart showing operations of the modulation system.

At first, when a user operates a power switch of the controller 6 in the FM modulator 2, power is supplied to the FM modulator 2 (step S1). Further, the user selects any of the reference frequency bands stored in the memory 13 by operating the controller 6 of the FM modulator 2 for data entry (step S2). Further the user operates a power switch not shown of the head unit 3 so that power is supplied to the head unit 3 and the head unit 3 is turned ON. Then the user sets a receiving frequency band area for the electric waves received by the head unit 3 to, for instance, an ultra-high frequency band area for FM broadcasting. Further the user sets a receiving area of the head unit 3 to the reference frequency band set in step 2 (step S3). Then the user operates the data reader connected to the FM modulator 2 to read data.

On the other hand, when the user performs the input operation for selecting a reference frequency band in step S2, the frequency controller 14 of the modulation apparatus 2 makes the FM level detector 11 detect the receiving levels of electric waves in the peripheral area. Further the frequency controller 14 compares the reference frequency bands correspond to various frequency band information stored in the memory 13 to the receiving levels detected by the FM level detector 11 one by one successively (step S4). Further the frequency controller 14 compares the receiving levels of electric waves in each of the reference frequency bands in which the levels were checked to each other (step S5). Then the frequency controller 14 selects a reference frequency band in which levels of the received electric waves are lowest (Step S6).

Then the frequency controller 14 controls the modulator 12 so that a frequency of the data read by the data reader is modulated to that in the selected reference frequency band. Further the frequency controller 14 provides controls to have the ID information for the selected frequency band information superimposed on the modulated data. Then the frequency controller 14 controls the transmitter to transmit the data modulated to the prespecified reference frequency band with the frequency band information superimposed thereon (step S7).

Then the information transmitted from the FM modulator 2 in this step S7 is received by the receiver 21 in the head unit 3. When the information is received, the FM multiplex decoder 25 of the head unit 3 fetches the frequency band information included in the information (step S8). When the frequency band information is fetched in this step S8, the system controller 23 in the head unit 2 verifies the ID information for the frequency band information included in the received information to the ID information for the frequency band information stored in the terminal memory 22 to identify frequency band information having the same ID information. Then the system controller 23 recognizes the reference frequency band corresponding to the identified frequency band information as the reference frequency band to which the data was modulated by the FM modulator 2. Then the system controller 23 controls the FM tuner 26 to make it fetch the data by processing the information received via a filter in the identified reference frequency band (step S9). Namely, the reference frequency band set by the user in step S3 is automatically changed to that corresponding to the frequency band information transmitted from the FM modulator 2.

After the reference frequency band is automatically set in step S9, the data fetched in the FM tuner 26 is sent to the reproducing apparatus, and is reproduced by the reproducing apparatus.

Further after the FM modulator 2 transmits the information in step S7, the frequency controller 14 in the FM modulator 2 controls the FM level detector 11 according to the necessity to make it detect receiving levels of the electric waves in the peripheral area. Then the frequency controller 14 determines whether the levels of the electric waves detected by the FM level detector 11 are over the preset threshold value Th stored in the memory or not (step S11).

In this step S10, when it is determined by the frequency controller 14 that the levels of the received electric waves are not over the threshold value, system control goes to step S6 to continue the processing of data modulation by the modulator 12 in the selected reference frequency band. If it is determined that the levels of the received electric waves are over the threshold value Th, system control goes to step S4 to execute the processing for again selecting a reference frequency band in which the levels of the received electric waves are lowest.

As described above, in the first embodiment of the present invention, the frequency controller 14 receives the electric waves in the peripheral area with the FM level detector 11 and identifies a reference frequency band in which the levels of the received electric waves are lowest, and then modulates the data with the modulator 12 in this reference frequency band. Because of this configuration, data modulation can automatically be executed in a frequency band where the influence by electric waves in the peripheral are is lowest, and it is not necessary to execute data modulation again by selecting anew a reference frequency band not affected by electric waves in the peripheral area even in different areas, which results in improvement of the convenience.

Further the FM tuner 26 is controlled so that the modulated data is transmitted with the frequency band information for data modulation superimposed thereon, the frequency band information is fetched by the head unit, and the data is automatically received in the reference frequency band corresponding to the frequency band information. Because of this configuration, even if a reference frequency band for data modulation is automatically set by the FM modulator 2, the head unit 3 automatically sets the reference frequency band for receiving the data, so that it is not necessary to adjust the head unit 3 by checking the reference frequency band for data modulation, which further improves the convenience.

Further superimposition of the frequency band information is performed in the form of digital signals. Because of this feature, in the configuration for modulating a frequency of data, the frequency band information can be superimposed on the data to be transmitted easily and efficiently. Data transmission and receiving can smoothly be executed between the FM modulator 2 and the head unit 3.

The reference frequency bands used for data modulation are previously stored in the memory as information for a plurality of frequency bands, and a reference frequency band in which receiving levels of electric waves are lowest is selected and used for data modulated by the modulator 12. Because of this configuration, a reference frequency band not affected by electric waves in the peripheral area can easily be set with the processing efficiency improved.

Further a prespecified threshold value Th is stored in the memory 13, and receiving levels of electric waves in the peripheral area in the reference frequency band for modulation is compared to the threshold value Th, and when the receiving levels of electric waves are over the threshold value, the reference frequency band is again selected and set. Because of this feature, data modulation can always be performed in a reference frequency band not affected by electric waves in the peripheral area.

[Second Embodiment]

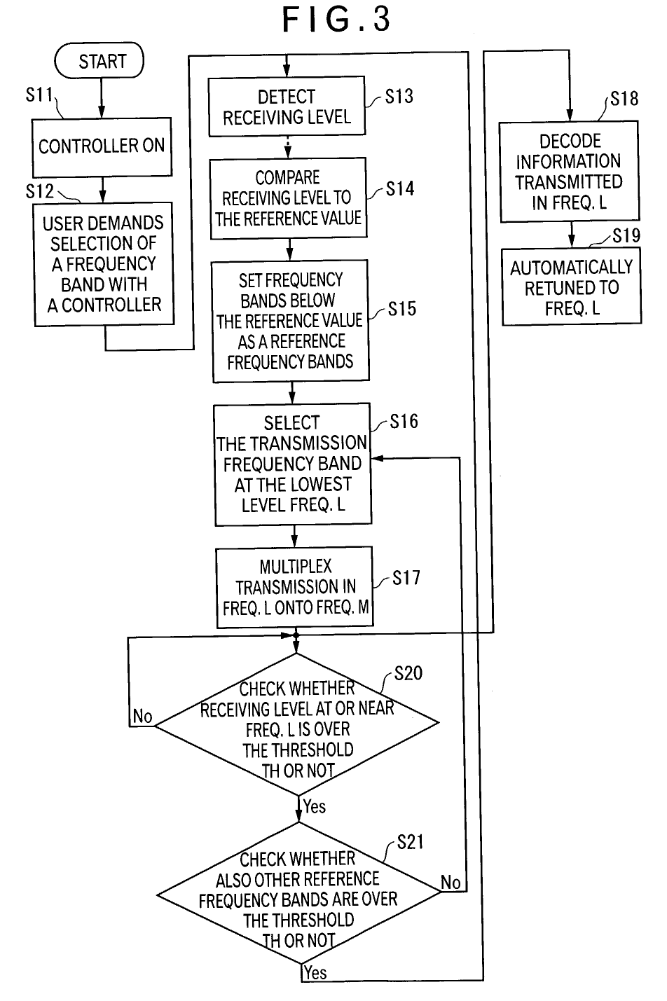

A modulation system according to a second embodiment of the present invention is described below with reference to the related drawings. The second embodiment is different from the first embodiment in the points that, different from the configuration in which data modulation is carried out in a reference frequency band in which level of received electric waves are at a low level, receiving levels are compared to the reference value as a threshold value previously specified and data modulation is carried out in the frequency band lower than the reference value. FIG. 3 is a flow chart showing operations of the modulation system. In the second embodiments, the same reference numerals are used for the same components as those in the first embodiment, and detailed description thereof is not made herein.

At first, when a user operates a power switch on the controller 6 of the FM modulator 2, power is supplied to the FM modulator 2 (step S11). Further, the user operates a power switch of the hear unit 3 not shown to supply power to the head unit 3 to turning ON the head unit 3. Further the user sets a receiving frequency band of electric waves received by the hear unit 3 to, for instance, an ultra-high frequency band for FM broadcasting.

Then the user operates the controller 6 of the FM modulator 2 to input data for setting a reference frequency band (step S12). In this case, when power supply to the FM modulator 2 is started, it is better for the user to indicate the reference frequency band with a display or voices.

When input of necessary data is complete in step S12, the frequency controller 14 of the modulation apparatus 2 provides controls so that the FM level detector 11 detects receiving levels of electric waves in the peripheral area (step S 13). Further the frequency controller 14 compares receiving levels of electric waves in the peripheral area detected by the FM level detector 11 to the reference value as a threshold value stored in the memory 13 (step S14). Then the frequency controller 14 detects a frequency band in which levels of the received electric waves are not more than the reference value, and the detected frequency band is set and stored as a reference frequency band in the memory 13 (step S15). Further, when there is a plurality of set reference frequency bands, of these reference frequency bands, that in which the levels of the received electric waves are lowest is used as the reference frequency band (step S16).

Then the frequency controller 14 provides controls so that the modulator 12 modulates data fetched by the data reader in the selected reference frequency band. Further the frequency controller 14 provides controls to superimpose frequency information for the selected reference frequency band on the modulated data. In succession to this operation, the frequency controller 14 controls the transmitter so that the modulated data with the frequency thereof having been modulated to the prespecified reference frequency band and the frequency band information superimposed thereof is transmitted (step S17).

The information transmitted from the FM modulator 2 in this step S17 is received by the head unit 3. When the information is received, the Fm multiplex decoder 25 of the head unit 3 fetches the frequency band information described in the received information (step S18). Then the system controller 23 recognizes the reference frequency band described in the fetched frequency band information as the reference frequency band to which a frequency of the data was modulated by the FM modulator 2. In succession to this operation, the system controller 23 provides controls for the FM tuner 26 so that the data is fetched by processing the received information with the filter in the recognized reference frequency band (step S19). Namely, the reference frequency band set by the user in step S12 is automatically changed to a reference frequency band described in the frequency band information transmitted from the FM modulator 2.

With this operation for automatically changing a reference frequency band in this step S19, the data fetched by the FM tuner 26 is sent to the reproducing apparatus, and is reproduced by the reproducing apparatus.

After the FM modulator 2 transmits the information in step S17, the frequency controller 14 of the FM modulator 2 provides controls for the FM level detector 11 according to the necessity so that it can detect level of received electric waves in the peripheral area. Then the frequency controller 14 determines whether the level of each of the received electric waves detected by the FM level detector 11 is over the prespecified threshold value stored in the memory or not (step S20).

In this step S20, when it is determined by the frequency controller 14 that the level of the received electric waves is not over the threshold value Th, the processing for modulating the data with the modulator 12 in the reference frequency band set in step S16 is continued. Further, in step S20, when it is determined by the frequency controller 14 that the level of the received electric waves is mover the threshold value Th, system control goes to step S16. Namely, a reference frequency band in which the receiving levels of electric waves are lowest is selected from other reference frequency bands stored in the memory 13 and the same processing is carried out. Further in step 21, when it is determined that the levels of the received electric waves are over the threshold value Th also in other reference frequency bands, system control goes to step S13, and the processing for selecting a reference frequency band in which the levels of the received electric waves are lower than the threshold value is again carried out. When it is determined in step S20 that the levels are more than the reference value Th, system control may be shifted not to step S16, but to step S13 to carry out the processing described above.

As described above, in the second embodiment of the present invention described above, a reference value as a threshold value to which receiving levels of electric waves are compared is previously set, and a frequency band in which the levels are not more than the reference value is used for data modulation. Because of this feature, it is not necessary to previously prepare a plurality of reference frequency bands, and a reference frequency band can freely be set in a frequency band in which levels of received electric waves are close to each other, so that data modulation can be carried out more smoothly. Further it is required to set only a reference value, which is advantageous for simplifying the configuration.

When there are a plurality of frequency bands, in each of which the receiving levels of electric waves are not more than the reference value, all of the frequency bands are set each as a reference frequency band, and of the plurality of reference frequency bands set as described above, one in which the levels are lowest is selected for data modulation. Because of this feature, data modulation can be carried out in a frequency least affected by electric waves in the peripheral area, so that data can be transmitted and received more smoothly. If receiving levels of electric waves in the selected reference frequency band become not suited to smooth communication, one of other reference frequency bands previously prepared is used, so that it is not necessary to again compares the receiving levels of electric waves to the reference value, which contributes to reduction of workload in the processing. Further because of the simple configuration in which a plurality of reference frequency bands are previously stored in the memory 13, the time required for switching to other reference frequency band can be reduced, which in turn result in improvement of the convenience.

[Variants of the Embodiments]

The present invention is not limited to the embodiments described above, and various variants are possible within the scope of the present invention.

Namely, although the description above assumes the configuration in which data such as music data read with a data reader connected to the FM modulator 2 is transmitted and is received by a head unit and reproduced with a reproducing apparatus, the present invention is not limited to this configuration, and the present invention may be applied to any configuration for data modulation.

The description above assumes the configuration in which information concerning a plurality of frequency bands is stored in the memory 13, receiving levels of electric waves are compared to each other, and a reference frequency band with the level of received electric waves lowest is selected for data modulation, but also the configuration is allowable in which levels for receiving electric waves are digitalized with a prespecified frequency space and a frequency band in which the numerical value is smallest is set as a reference frequency band for data modulation.

The description above assumes the configuration in which a reference frequency band is set by a user in step S2 and then a reference frequency band not affected by electric waves in the peripheral area is automatically set, but the configuration is allowable, for instance, in which a user carries out the processing for setting a reference frequency band not affected by electric waves in the peripheral area by inputting necessary data.

The above description assumes the configuration in which data with the frequency band information superimposed thereon is transmitted and the head unit automatically receives the data, but the configuration is allowable, for instance, in which the frequency band information is not superimposed, information for a reference frequency band not affected by electric waves in the peripheral area is notified to users with a reporting device such as a display unit or a sound generating device connected to the FM modulator 2, and a reference frequency band for receiving data with the head unit 3 is set according to contents of the reported information, or in which data with frequency band information superimposed thereon is transmitted to the head unit 3 to report the information to a reporting device connected to the head unit 3, and then a user sets a reference frequency band for receiving the data with the head unit.

The configuration is also allowable in which the threshold value is not set, system control returns, for instance, after the step S7, to step S4, if required, to again set a reference frequency band in which receiving levels of electric waves are lowest.

The specific configurations each for carrying out the present invention and the procedure for recognizing occurrence of any trouble or the like may be modified within the scope in which objects of the present invention can be achieved.

What is claimed is:

1. A modulation apparatus comprising:
a data fetching section for fetching data;
a level detector for receiving electric waves in a peripheral area and detecting levels thereof;
a frequency configurator for setting, based on receiving levels of electric waves detected by the level detector, a frequency band in which the level of received electric wave is low as a reference frequency band; and
a modulator for modulating the data fetched with said data fetching section in the reference frequency band set by the frequency configurator.

2. The modulation apparatus according to claim 1 further comprising:
a storage for storing therein information concerning a plurality of different reference frequency bands, wherein said frequency configurator compares receiving levels of electric waves in the reference frequency bands stored in said storage at the receiving level detected by the level detector, and sets the frequency band in which the receiving level is lowest as the reference frequency band.

3. The modulation apparatus according to claim 1, wherein said frequency configurator compares the receiving levels detected by the level detector to a reference value previously set to recognize frequency bands in which the receiving levels are not more than the reference value, and selects one of the frequency bands recognized as described above as a reference frequency band.

4. The modulation apparatus according to claim 1 further comprising:
a transmitter for transmitting the modulated data and frequency band information concerning the reference frequency band to which a frequency of the data was modulated.

5. The modulation apparatus according to claim 4, wherein said transmitter transmits the modulated data with the frequency band information superimposed in a form of a digital signal.

6. Modulation method for modulating data fetched by a computing section to a prespecified frequency band, said method comprising the steps of:
receiving electric waves in the peripheral area to detect the receiving levels;
identifying a frequency band in which the detected receiving level is lowest to select the frequency band as a reference frequency band;
and modulating the fetched data in the selected reference frequency band.

7. The modulation method according to claim 6, wherein said computing section comprises a storage for storing information concerning a plurality of reference frequency bands in different frequency bands compares the receiving levels of electric waves in the peripheral area to those in the reference frequency bands stored in said storage, and selects the frequency band in which the receiving level is lowest.

8. The modulation method according to claim 6, wherein said computing section compares the receiving levels of electric waves in the peripheral area to a reference value previously set, identifies frequency bands in which the receiving levels are not more than said reference value, and selects at least one of the identified frequency bands as a reference frequency band.

9. The modulation method according to claim 6, wherein said computing section transmits the modulated data and frequency band information concerning the reference frequency band to which a frequency of the data was modulated.

10. The modulation method according to claim 9, wherein said computing section transmits the modulated data with the frequency band information superimposed thereon in a form of a digital signal.

11. A modulated wave receiving apparatus comprising:
an information fetching section for fetching the frequency band information concerning the reference frequency band to which a frequency of the data was modulated by the modulation apparatus according to claim 1; and
a data receiver for etching said modulated data by attenuating signals other than those in the reference frequency band included in the frequency band information fetched by the information fetching section.

12. A modulated wave receiving apparatus comprising:
an information fetching section for fetching the frequency band information concerning the reference frequency band for the data modulated by the modulation apparatus according to claim 2;
a terminal storage for storing therein information concerning a plurality of reference frequency bands corresponding to a plurality of different frequency bands stored in the storage of said modulation apparatus; and
a data receiver for receiving said modulated data by identifying, based on the frequency band information fetched by said information fetching section, a corresponding reference frequency band stored in said terminal storage and further by attenuating signals other than those in the reference frequency band.

13. A modulation system comprising:
the modulation apparatus according to claim 1; and
the modulated wave receiver according to claim 11.

14. The modulation system according to claim 13 further comprising:
a reproducing apparatus for reproducing the data fetched by the data fetching section in the modulated wave receiver according to claim 11.
